(19) United States
(12) Patent Application Publication
(10) Pub. No.: US 2007/0293158 A1
(43) Pub. Date: Dec. 20, 2007

(54) Test apparatus and method for a wireless transceiver

(76) Inventor: Janice Chiu, (US)

Correspondence Address: BRAKE HUGHES BELLERMANN LLP, C/O INTELLEVATE, P.O. BOX 52050, MINNEAPOLIS, MN, 55402, US

(21) Appl. No.: 11/455,798

(22) Filed: Jun. 19, 2006

(51) Int. Cl. H04B 17/00

(52) U.S. Cl. 455/67.11

(57) ABSTRACT

An apparatus and method are described that provide efficient testing of an integrated circuit wireless transceiver. A digital to analog converter and suitable connection and control logic are integrated on the chip to allow testing of the internal parts of the transceiver by selecting one of a number of predefined test points within the transceiver circuitry. The control logic may configure the digital to analog converter differently, depending on which test point is selected. Also, the digital to analog converter may experience an offset voltage, depending on which test point is selected. Thus, the digital to analog converter may be a current-source digital to analog converter having an offset current source to counter the offset voltage.

### BACKGROUND

Wireless transmitters and receivers are used in many applications. For example, such applications may include computer communications systems and wireless cell phones. To reduce the cost and complexity of designing and manufacturing such wireless communication devices, and to reduce a size of such devices, much of the related circuitry may be integrated onto a small number of integrated circuit chips.

Recent technology advances have made it possible to integrate essentially all of the transmit and receive circuitry onto a single transceiver chip. As the circuitry becomes more highly integrated it may be more difficult to test the performance of parts of the transceiver. This problem may be further exacerbated, for example, by the digital nature of much of the circuitry, and/or by conversions between analog and digital signals (or vice-versa) during operation of the transceiver.

### SUMMARY

According to one general aspect, an apparatus for testing an integrated circuit wireless transceiver includes a digital to analog converter having an input, and connection logic, operably connected to a first test point and a second test point within the wireless transceiver and also operably connected to the input of the digital to analog converter, the connection logic being configured to provide at least a first connection path and a second connection path between the first test point and the second test point, respectively, and the input of the digital to analog converter. The apparatus also includes control logic operably connected to the connection logic and the digital to analog converter and configured to activate the first connection path or the second connection path.

According to another general aspect, a method of providing an integrated test capability for an integrated circuit wireless transceiver is provided. A digital to analog converter having an input is provided. A first test point and a second test point are provided within the wireless transceiver that each are switchably connected to the input of the digital to analog converter by way of at least a first connection path and a second connection path between the first test point and the second test point, respectively, and the input of the digital to analog converter. Control logic is provided that is configured to activate the first connection path or the second connection path in response to a selection signal.

According to another general aspect, a method of testing a performance of an integrated circuit wireless transceiver is provided. A selection signal designating at least a first test point of at least a first test point and a second test point within a wireless transceiver is provided, and a connection path is activated between the first test point and a digital to analog converter, based on the selection signal. An output of the digital to analog converter is provided at a comparison circuit, and a test signal associated with the wireless transceiver to the comparison circuit is provided. The test signal is tested, based on an output of the comparison circuit.

According to another general aspect, a digital to analog converter includes a plurality of current sources, at least one bias generator configured to activate a subset of the plurality of current sources, based on a received digital signal, an offset current source, and an offset bias generator configured to activate the offset current source in response to an offset select signal indicating a presence of an offset within the received digital signal.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless transceiver with additional testing elements added.

FIG. 2 is a flow chart showing an implementation of a method for testing the operation of an integrated circuit wireless transceiver.

FIG. 3 is a block diagram of an example of a receiver and test circuitry of FIG. 1.

FIG. 4 is a block diagram of a current mode digital to analog converter (iDAC) that may be used in the text circuitry of FIGS. 1 and/or 3.

FIG. 5 is block diagram of an example output stage for the current mode digital to analog converter (iDAC) of FIG. 4.

FIG. 6 is a table showing how a four bit input signal is translated into a 15 bit control signal for the current mode digital to analog converter (iDAC) of FIG. 4.

FIGS. 7A-7C are graphs showing sample test outputs illustrating effects example operations of the current mode digital to analog converter (iDAC) of FIG. 4.

### DETAILED DESCRIPTION

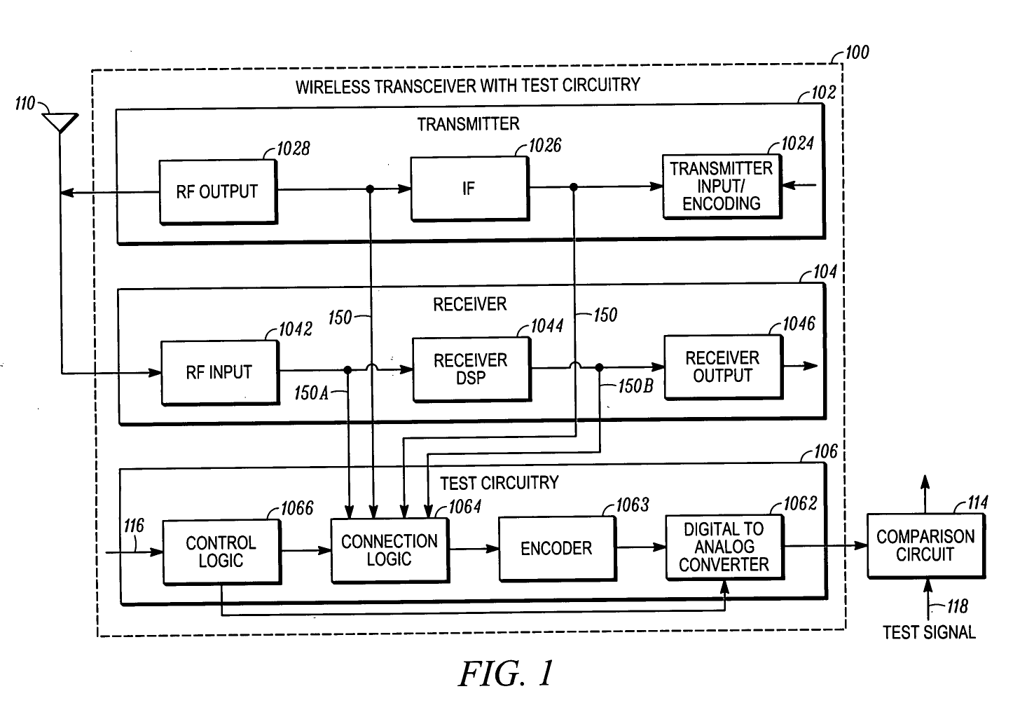

FIG. 1 is a block diagram of a system 100 including a wireless transceiver with additional testing elements added. The wireless transceiver of the system 100, as referenced above, generally includes a transmitter 102 and a receiver 104, so as to provide wireless transmission and reception of data signals, respectively. For example, such a wireless transceiver may be used in cell phones, GPS systems, or other communication systems.

The transmitter 102, receiver 104, or other elements or sub-elements may generally include various components and circuitry to receive, process, or transmit analog and/or digital data signals, and such components and/or circuitry may be susceptible to malfunction, or may require calibration. The system 100 is configured to provide easy, flexible, and reliable testing of a selected one of the components or circuitry, by, for example, providing for the selection of a plurality of connection paths to a corresponding plurality of test points within the system 100.

In this way, for example, a user may test any of the plurality of test points within the wireless transceiver, while only using one instance of associated test circuitry. As a result, for example, when the system 100 is substantially implemented as a single integrated circuit chip, space on the chip may be conserved, while the user is nonetheless provided with a number of convenient options and possibilities for testing the wireless transceiver 101, so as to determine an existence, source, nature, or severity of a malfunction.

In FIG. 1, the transmitter 102,is configured to process outgoing data signals for transmission from the wireless transceiver. For example, the transmitter portion 102 may perform signal encoding, modulation, analog/digital conversion, or otherwise may process incoming data signals to be suitable for a desired type of transmission thereof.

In the example of FIG. 1, the transmitter portion 102 includes, for the purposes of this description and associated examples, three functional blocks. The first of these is a transmitter input and encoding block 1024 that is configured to receive a data stream that is to be transmitted and formats it to be consistent with the transmission mode that the transmitter 102 uses. For example the data stream might be an analog signal representing voice data, or digital data from a computer. The formatting action might include, for example, sampling and digitization of any analog data.

Formatted data from the input/encoding block 1024 is then sent to a transmitter Intermediate Frequency (IF) block 1026. Here, the data may be modulated onto a Radio Frequency (RF) carrier, and may be frequency-shifted to the desired output frequency. The modulated and frequency-shifted RF signal may then be sent to the transmitter RF output stage 1028, where it is amplified and impedance matched to an antenna 110.

Of course, there are a variety of ways of implementing a transmitter stage in a transceiver, and the above description is provided as an example, and is not intended to be a definitive description of such a stage.

In the receiver 104, RF signals from the antenna 110 are first sent through a receiver input 1042. For example, the receiver input may include amplification of the weak RF signal, followed by frequency downshifting to a lower intermediate frequency. The received data may then be digitized, so that the output from the RF input 1042 may include a stream of digital data.

Further processing of the (now digitized) data stream takes place in the receiver digital signal processor (DSP) 1044. The digital signal processor 1044 may be associated with, for example, bandpass filtering, further amplification, down conversion of the IF signal to baseband with image rejection, and/or gain and phase control.

The output of the receiver DSP 1044 may then be sent to a receiver output 1046. For example, the receiver output 1046 may be configured to re-format the data stream to be compatible with the baseband processing circuitry off the transceiver chip.

It will be understood by those versed in the art that the above description is intended to convey the general properties of a wireless receiver, and that the many details of various examples of such circuitry are well understood.

A potential problem with a highly integrated circuit like the transceiver in FIG. 1 is that it may be difficult to test the operation of some of the internal modules. Therefore it would be desirable to provide some sort of testing mechanism integrated on the transceiver chip proper. Accordingly, FIG. 1 includes test circuitry 106. The test circuitry includes various modules in the example of FIG. 1.

For example, the test circuitry 106 includes a digital to analog converter (DAC) 1062 that is configured to receive a digital signal from the transmitter 102 or the receiver 104, and to convert the digital signal into an analog signal. The test circuitry 106 also includes an encoder 1063 that is configured to encode the digital signal in a format that is compatible with the particular type of DAC 1062 that is being used, for input to the DAC 1062. For example, as described in more detail below, the DAC 1062 may include a current-source DAC (iDAC) in which various ones of a plurality of available current sources are activated in response to the digital signal. In this case, the encoder 1063 may include, for example, a binary-to-thermometer encoder that provides thermometer code formatted for input to the various current sources.

The test circuitry 106 also includes connection logic 1064 that is configured to allow one or more test points within the transceiver circuitry to be connected to the digital to analog converter 1062, as shown. The test points are switchably connected to the connection logic 1064 by way of a plurality of corresponding connection paths 150.

Control logic 1066 is configured to receive a selection signal 116 and direct the connection logic 1064 to activate a specific one of the test paths 150, so as to connect a particular test point to the digital to analog converter 1062. The selection signal 116 may come, for example, from either another part of the transceiver circuitry, or, perhaps more typically, from outside of the transceiver chip itself. The control logic 1066 may include, for example, a control register in which pre-determined registeribit values are used to activate an appropriate connection path.

The system 100 may represent circuitry that is all included on the transceiver chip, and a comparison circuit 114 may be provided off-chip. Thus, the output of the digital to analog converter 1062 may be fed to the comparison circuit 114.

Then, a test signal 118 may be provided to the comparison circuit 114. For example, the test signal 118 may include an analog signal taken from a specified point associated with the receiver 104. For example, the RF input 1042 may receive an analog signal from the antenna 110, and may include an analog to digital converter within the RF input 1042. It may be desirable to compare the (digital) output of the RF input 1042 to the (analog) signal received at the antenna 110. Therefore, in order to make a meaningful comparison, the test circuitry 106 may be used to select a digital signal output by the RF input 1042, convert the digital signal to an analog signal, and provide the converted analog signal to the comparison circuit 114. By inputting the test signal 118, e.g., the input from the antenna 110, a comparison may be made between the test signal 118 and the signal that is output by the RF input 1042. In this way, for example, a malfunction of an analog to digital converter within the RF input 1042 may be deduced.

As described, then, the test circuitry 106 may be used to test a plurality of the test points 150. For example, the receiver may be included in a Global System for Mobile Communication (GSM) and/or an Enhanced General Packet Radio system (EDGE) transmitter or receiver, and the test circuitry 106 may be used to easily output and determine, for example, a malfunction, if any, of components of the transmitter/receiver associated with a given test point(s).

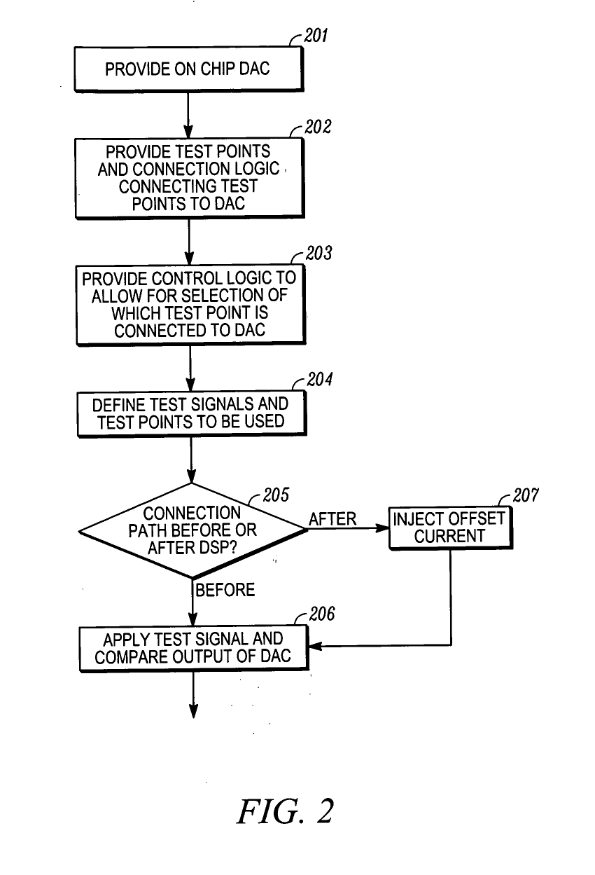

FIG. 2 is a flow chart showing an example implementation of a method for testing the operation of an integrated circuit wireless transceiver. FIG. 2 shows how including the test circuitry 106 on the chip allows designers of the chip and users of the chip to test the performance of the individual parts of the transmitter 102 and/or the receiver 104.

First, the components of the test circuitry 106 may be included on the chip. For example, the DAC 1062 may be provided on the chip (201). Then, the test points may be defined, and suitable connection logic provided that allows the selected test points to be connected to the DAC (202). Control logic may be provided that allows a tester to select which of the set of test points is connected to the DAC (203).

A set of test signals may be defined for each element of the transceiver that is to be tested (204). For example, this set of test signals may include definition of the content and characteristics of each signal to be tested, the corresponding test point(s) to be selected, an appropriate input of the transceiver chip at which the test signal is to be provided, and/or a reference signal to compare the output of the DAC to. By choosing a test point to be connected to the DAC, the corresponding digital data stream may be converted back into its equivalent analog data stream and, e.g., monitored by the designers or users of the system 100.

In some implementations, different test points may be associated with different uses of, for example, the control logic 1066 and/or the DAC 1062. For example, as referenced herein, it may be the case that certain processing may be performed in the receiver DSP 1044 and/or the connection logic 1064 that causes an offset voltage to be present at the input of the digital to analog converter 1062. In this case, it may be useful to inject a counter-balancing offset current within the digital to analog converter 1062, in order to preserve a symmetry of the output signal of the digital to analog converter 1062.

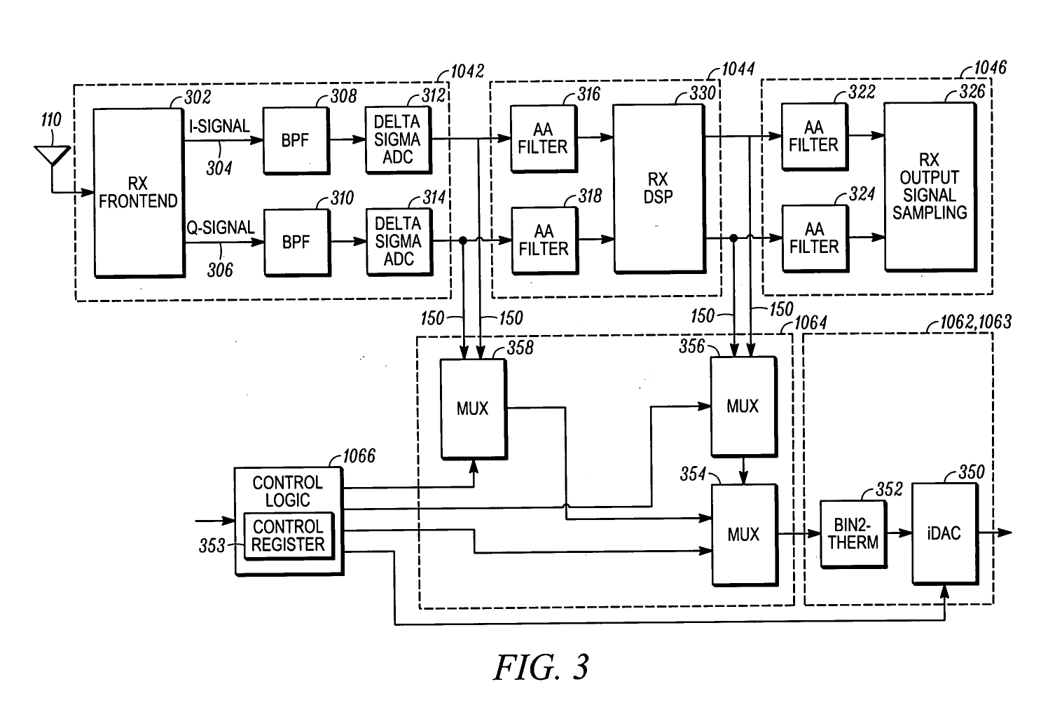

Examples of such scenarios are provided in more detail below, e.g., with respect to FIGS. 3-7. For the purposes of FIG. 2, however, it should just be understood that the control logic 1066 may influence a behavior or operation of the digital-to-analog converter 1062 in different ways, depending on which test point and/or connection path is chosen to the receiver 104.

In the example provided in FIG. 2, then, a determination may be made, e.g., by the control logic 1066, as to whether a selected test point occurs before or after the receiver DSP 1044 (205). If before, then no offset may be needed, and the signal from the test point 150a may be input directly to the encoder 1063 and the digital to analog converter 1062, so that a desired test signal may be selected for comparison with an output of the digital to analog converter 1062 (206).

If, however, the selected test point and associated connection path occurs after the receiver DSP 1044 (205), then it may be necessary to take a corresponding action, such as, for example, injecting an offset current at the digital to analog converter 1062 (207). In this way, for example, a symmetry of the output of the digital to analog converter 1062 may be preserved when, for example, applying the output to the comparison circuit 114.

Thus, for example, the output of the DAC can be compared to a provided reference signal which is part of the test signal set. The reference signal allows the tester to verify that the data stream at the chosen test point is consistent with the design of the chip and the chosen input test signal. This comparison may be carried out, for example, by visually observing the output waveform from the DAC, and/or by using the comparison circuit 114 in FIG. 1. For example, the comparison circuit 114 may compare the output of the DAC 1062 to the test signal 118 (e.g., a reference signal). By choosing enough test points, it is possible for the designers of the chip to ensure that all the key elements of the transceiver can be checked after the chip is manufactured.

For example, it is possible to test the DSP 1044 in FIG. 1. To do so, the tester may apply a chosen signal to the input to the receiver 104. Two test points would be provided, one at the input to the DSP stage (shown as 150a), and one at the output of the DSP stage (shown as 150b). By first choosing test point 150a, the tester may observe that the input to the DSP 1044 is consistent with the design of the chip and the chosen input signal. By then keeping the input signal and all other parameters constant and switching to test point 150b, the tester may check that the output of the DSP 1044 is consistent with the design of the DSP stage and the chosen input signal. This process may be carried out for a variety of test input signals. In an analogous fashion, other stages of the receiver 104, or the transmitter 102, of the wireless transceiver may be tested.

FIG. 3 is a block diagram of an example of the receiver 104 and the test circuitry 106 of FIG. 1. In the example of FIG. 3, as part of the downconverting process in the Receiver RF input stage 1042, an RX frontend 302 is configured to convert the input signal into a pair of lower frequency, higher amplitude signals which are 90 degrees out of phase, which are conventionally referred to as the I-data or I-signal 304, and the Q-data or Q-signal 306. The I and Q signals 304, 306 are processed in parallel throughout the rest of the receiver data path, e.g., to improve the overall signal to noise ratio of the system.

The I signal 304 and the Q signal 306 are bandpass-filtered in filter elements 308 and 310. Such filtering, for example, may limit effects of spurious signals near the original signal frequency. After filtering, the I signal 304 and the Q signal 306 are each digitized, using, for example, delta-sigma analog to digital converters 312, 314, as shown. The output of these converters is fed to the Receiver DSP 1044.

The Receiver DSP stage 1044 includes a pair of anti-aliasing filters 316 and 318 for each of the I and Q data streams. These filters, for example, may ensure that signals outside of the passband, determined by the sampling frequency and the corresponding Nyquist limits, are eliminated prior to any actual digital signal processing. The output of these filters feeds a Receiver DSP stage 320, where the various gain and digital signal processing functions are performed.

The output of the Receiver DSP stage 220 is fed to the receiver output module 1046. The receiver output module contains another pair of anti-aliasing filters, 222 and 224 to, e.g., filter any spurious frequencies that are left after the digital signal processing. The output of these filters is fed to the receiver output signal sampling stage 226, where the signals are formatted for the baseband processing circuitry, which is typically off-chip.

The test mechanism 106 is also shown in more detail in FIG. 3. The encoder 1063 and Digital to Analog converter 1062 are represented in FIG. 3, respectively, as a binary-to-thermometer code (“Bin2Therm”) converter 352 and a iDAC 350. The iDAC 350 may employ a number of matched current sources, whose outputs are summed to give the analog output of the iDAC. As part of the output, these summed currents are passed through a resistor to convert the current to a voltage. The Bin2Therm converter 352, as referenced above, is an example of an encoder/decoder, e.g., a data format converter, used to drive the iDAC 350. For example, the Bin2Therm may convert a 4 bit binary value at the input to the Bin2Therm stage into a 15 bit control signal to the iDAC, where the number of “1” bits in the control signal is equal to the value of the 4 bit input data to the Bin2Therm converter 352.

The control logic 1066 in FIG. 3 includes a control register 353. Register values of the control register 353 may be set, in response to the selection signal 116, so as to control the connection logic 1064.

Specifically, the connection logic 1064 in FIG. 3 comprises three digital multiplexers 354, 356, and 358. The input to multiplexer 358 is shown as connected to the I and Q data signals 304, 306 at the input to the DSP stage 1044, i.e. at the output of the Delta-Sigma ADCs 312 and 314. Meanwhile, the inputs to multiplexer 356 are connected to the I and Q data paths 304, 306 at the output of the DSP stage 1044, i.e. at the outputs of the Receiver DSP module 330. The outputs of multiplexers 356 and 358, in turn, are fed to the two inputs of multiplexer 354. The output of the multiplexer 354 is, in turn, fed to the input to the Bin2Therm converter.

The control logic 1066 is shown connected to the control inputs of the three multiplexers 354, 356 and 358. By various combinations of these, the control signals from the control logic 1066 may specify any of the four test points chosen, e.g., the I and Q data at the input and the I and Q data at the output of the Receiver DSP stage 330 can be individually connected to the Digital to Analog Converter, and hence be made available for examination.

The example configuration of FIG. 3 illustrates how four separate test points can be monitored. The example is not limiting, in that the number of test points is not limited to four. Fewer or more test points can be connected, e.g., by modifying the connection logic. For example, the multiplexers 356 and 358 may be made with more than 2 inputs, or additional multiplexers could be added. In any case, by choosing combinations of multiplexers, or other appropriate connection logic, many different numbers of test points can be connected. Additionally, or alternatively, other logical connections not using multiplexers may be employed.

The example above assumes, for simplicity, that all connection paths 150 have the same bit depth, e.g., the same number of bits, and/or levels of code, per data element. It is possible, however, that data paths with different bit depths or different bit codings may be used. For example, in FIG. 3, it should be understood that an output of the delta sigma ADC 312, 314 is typically 4 bits, while an output of the RX DSP 330 may be represented as 16-level thermometer code. In such cases, the connection logic 1064 may include suitable data format conversion elements in conjunction with an associated one of the multiplexers 354-358, as would be apparent.

For example, in the latter case just mentioned, an interpolation filter and/or RX delta sigma modulator (DSM) component(s) may be connected to an output of the multiplexer 356, so that the multiplexer 354, and ultimately the bin2therm converter 352, receive(s) an appropriate 4 bit signal. In a case where such elements are not used, for example, a 16-level output of the DSP 330 may be applied directly to the DAC 350, since in this case the conversion of the bin2therm 352 may not be needed.

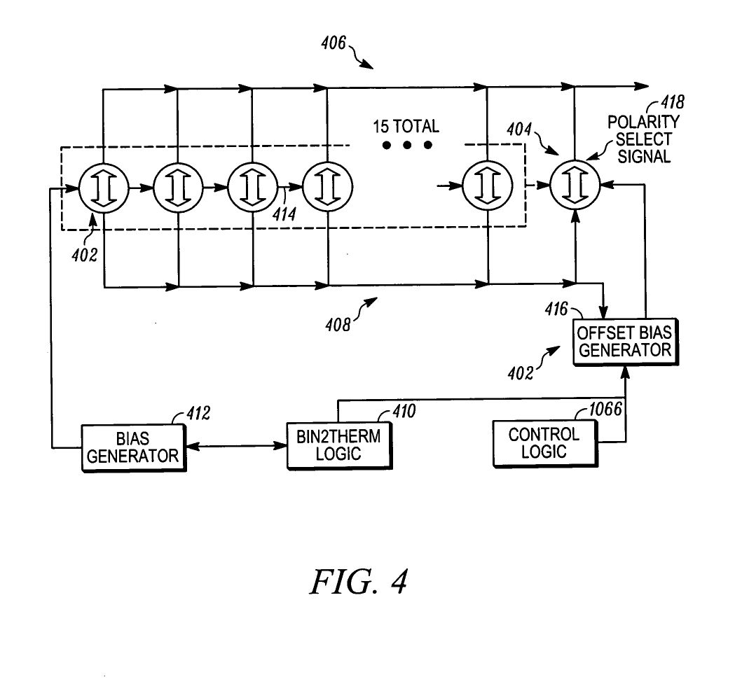

FIG. 4 is a block diagram of an example implementation of the iDAC 350. As referenced above, and as should be apparent, an analog output of the iDAC 350, generally speaking, may be single-ended or double-ended (i.e., differential). In the example of FIG. 4, the iDAC 350 is illustrated as a differential circuit that includes 15 matched current sources 402 and a 16^{th} current source 404. Outputs of the current sources 402, 404 may be tied together, and output by way of a positive bus 406 or a negative bus 408, as shown.

Each current source 402, and possibly the current source 404, may be controlled by one bit of the output from Bin2Therm logic 410. Outputs from the Bin2Therm logic 410 may, for example, turn the current sources 402, 404 positive or negative (or on or off), depending on the logic state of the associated bit, as determined from an output of the Bin2Therm encoder 352. The Bin2Therm logic 410 may be operably connected to a bias generator 412 that is configured to apply a bias signal to the current sources 402, 404 by way of a common bus 414.

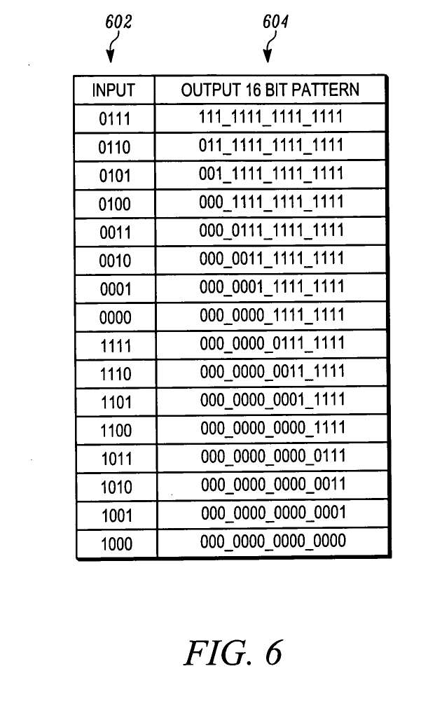

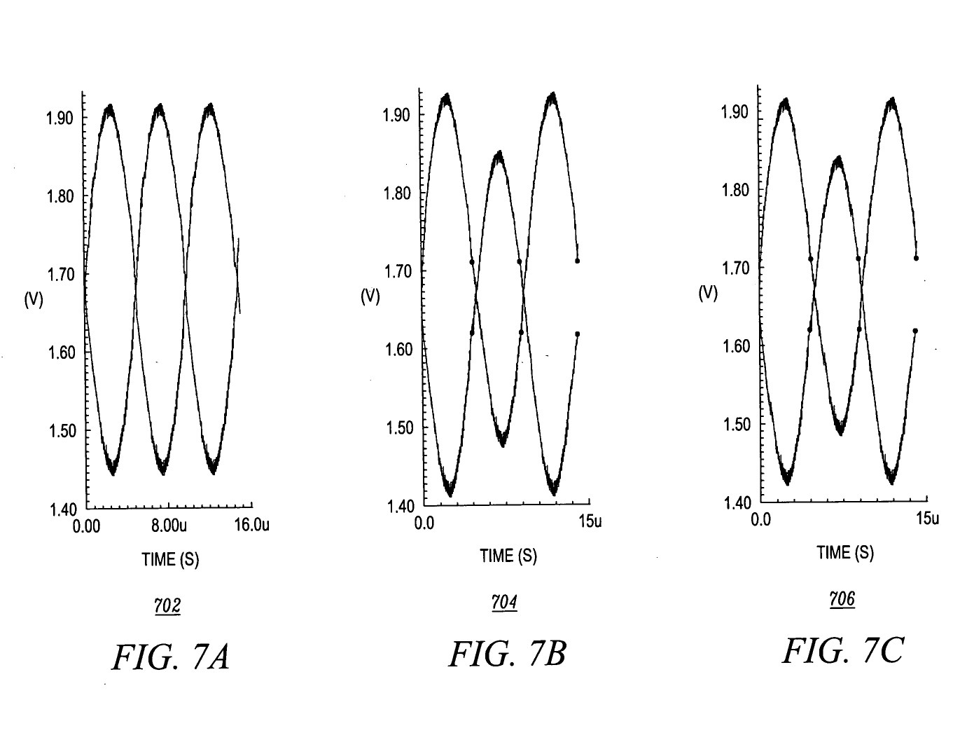

As referenced above, and discussed in more detail below with respect to FIGS. 6 and 7, operation of the current sources 402, 404 of the iDAC 350 may vary, depending, for example, on which test point is selected within the receiver 104. For example, it may be the case that the 15 current sources 402, or all 16 of the current sources 402, 404, may be used to provide a symmetrical, differential analog output.

As another example, it may be the case that only the 15 current sources 402 are activated by the Bin2Therm logic 410. Then, if necessary to preserve symmetry in an output of the iDAC 350 (e.g., due to a common mode DC offset in the output of the iDAC 350), as discussed herein, the 16th current source 404 may be used as an offset current source. In this case, an offset bias generator 416 may be used to apply the offset current source 404 to the output(s) of the iDAC 350. For example, the control logic 1066 may determine that the offset current source 404 is needed as such, and may activate the offset bias generator 416 by way of an appropriate data signal and/or register value. In this way, an undesired offset in the output of the iDAC 350 may be mitigated or removed. Additionally, the control logic 1066 may activate a polarity signal 418 that governs application of the offset, so that the offset of the current source 404 is applied so as to counter the undesired offset present in the output (as opposed to enhancing the undesired offset, as could occur if the polarity of the offset current source 404 is incorrect).

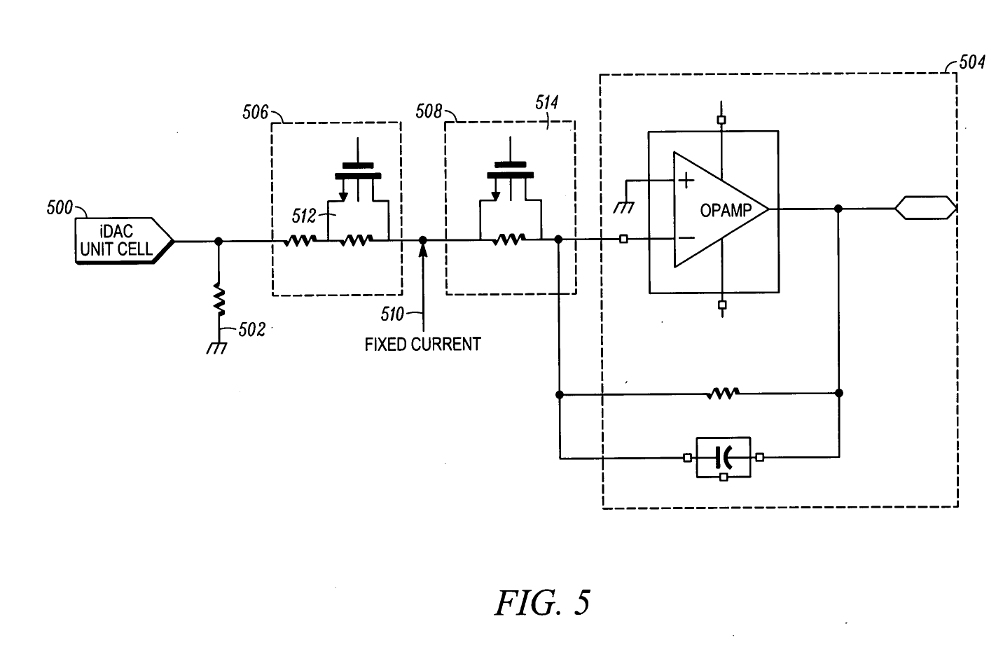

FIG. 5 is a circuit diagram illustrating a manner in which the output of an iDAC unit cell 500 may be turned into a voltage signal. In FIG. 5, an output current from the iDAC is passed through a resistor 502, thus converting the current to a voltage.

FIG. 5 also includes circuitry that allows for gain controlled amplification of the voltage signal, as well. Element 504 is an operational amplifier, shown in FIG. 5 as a simple inverting op amp configuration. Other configurations may be chosen at the discretion of a designer, as would be apparent. Additional circuitry is shown that illustrates injection of a fixed offset current 510, which, e.g., may be used to provide an input common-mode voltage to the operational amplifier 504, so that, for example, the operational amplifier 504 may be operated in a desired operating region.

Elements 506 and 508 are a combination of resistors and switches that allow for gain control of the circuit. Since the overall gain of the opamp circuit depends partly on the value of the input series resistance, the gain may be varied by means of transistor switches 512 and 514. For example, when either switch is activated, the resistor that it is placed across is effectively shorted out, thus changing the input series resistance and hence the overall gain.

Although FIG. 5 illustrates a single-ended circuit, it should be understood, e.g., from the discussion above of FIG. 4, that a double-ended, or differential, circuit may be used, and that such a differential circuit would be expected to be used with the differential current source(s) of the example of FIG. 4.

FIG. 6 is a table showing an example of decoding logic for the Bin2Therm encoder 352. Each of the sixteen possible four bit values has a corresponding 16 bit pattern. The left column, 602, lists the sixteen possible 4 bit combinations. The right column, 604, shows the 16 bit pattern that the Bin2Therm logic outputs.

Since each bit may control one current source, e.g., of the current sources 402, it is possible to turn on any of 16 different levels of current from the iDAC. In the coding in FIG. 6, the input values may be 4-bit 2's complement binary numbers, where the most significant bit represents a sign bit. Hence all the input values between 1000 and 1111 can be considered as negative numbers. At some test points, data stream may represent signed 4 bit 2's complement numbers. If the data signals are supposed to be symmetrical about the zero value, then there is an asymmetry in the table since there are eight negative numbers but only 7 positive numbers. Hence, the offset current source 404 may be used to add an offset equivalent to ½ bit to the output of the iDAC 350, in order to preserve the waveform symmetry.

However, if the data stream represents values varying from zero to some larger value (in magnitude) then there is no need to preserve symmetry and the offset may not be needed. When the test points are chosen the designer can add to the control logic a control signal that reflects the need to set the offset bit for those test points where the data stream represents signed 4 bit 2's complement numbers.

In other examples, however, the offset current source 404 may not be needed as such, and either may be disconnected/unused, or may be used as a 16^{th} current source of the iDAC 350. For example, when a selected test point includes the test point 150a, i.e., from the ADC(s) 312, it may be the case that the output of the digital to analog converter 350 is provided as 4 bit 1's complement binary output(s). In this case, there may be 16 combinations of the bin2therm output 352, and a symmetry of the output may be maintained.

FIGS. 7A-7C show sample test outputs showing effects of choosing the various polarity and offset combinations. In these figures a test signal has been applied and the output of the DAC is shown with three different combinations of the offset and polarity select signals. In FIG. 7A, the trace 702 shows both the polarity and offset bits are correctly selected. As shown, the two waveforms may be 180 degrees out of phase with each other, and symmetrical about the midpoint and may share a common midpoint value.

In FIG. 7B, the trace 704 shows an example in which the offset signal is correct, and polarity bits are set incorrectly for the signals. The signals are reversed in polarity from the expected output as shown in 702, and their midpoint values may be offset from one another. Finally, in FIG. 7C, the trace 706 shows an example in which the polarity is correctly selected, but the offset bit is not. In this example, then, the waveforms have the proper polarity, but they are still offset from one another.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. An apparatus for testing an integrated circuit wireless transceiver comprising:
a digital to analog converter having an input;
connection logic, operably connected to a first test point and a second test point within the wireless transceiver and also operably connected to the input of the digital to analog converter, the connection logic being configured to provide at least a first connection path and a second connection path between the first test point and the second test point, respectively, and the input of the digital to analog converter; and
control logic operably connected to the connection logic and the digital to analog converter and configured to activate the first connection path or the second connection path.

2. The apparatus of claim 1 wherein the digital to analog converter, the connection logic and the control logic are integrated on an integrated circuit chip with circuitry of the wireless transceiver.

3. The apparatus of claim 1 wherein the control logic is configured to activate the first connection path or the second connection path, based on a selection signal received thereat.

4. The apparatus of claim 3 wherein the selection signal designates the first or second connection path, and in addition designates an offset and polarity of an output of the digital to analog converter.

5. The apparatus of claim 1 wherein the control logic is configured to operate the digital to analog converter differently, based on which of the first connection path and the second connection path is selected.

6. The apparatus of claim 1 wherein at least the first test point is connected to an input of a digital signal processing stage of the wireless transceiver, an output of an analog to digital converter, an output of a digital signal processing stage of the wireless transceiver, and/or an input of a filter.

7. The apparatus of claim 1 wherein the control logic comprises a register configured to activate the first connection path or the second connection path based on predetermined register values.

8. The apparatus of claim 1 wherein the connection logic comprises a plurality of multiplexers connected between the first test point, the second test point, and the digital to analog converter.

9. The apparatus of claim 1 comprising an encoder operably connected between the connection logic and the digital to analog converter, and configured to provide a first test signal from the first test point in a format compatible with the input of the digital to analog converter.

10. The apparatus of claim 1 wherein the digital to analog converter comprises:
a plurality of current sources;
a bias generator configured to activate one or more of the plurality of current sources, in response to a test signal received from the first or second test point; and
summation logic configured to sum the outputs of the activated current sources.

11. The apparatus of claim 9 wherein the digital to analog converter includes an offset current source that is activated by the control logic in response to selection of the first connection path, and wherein the offset current source is configured to provide for a predetermined offset to the analog output of the digital to analog converter.

12. The apparatus of claim 1 wherein an output of the digital to analog converter is operably connected to an amplifier that is configured to allow the addition of an offset voltage to an output voltage of the digital to analog converter.

13. The apparatus of claim 1 wherein the digital to analog converter is configured to generate signals of either positive or negative polarity in response to a current control signal from the control logic.

14. A method of providing an integrated test capability for an integrated circuit wireless transceiver comprising:
providing a digital to analog converter having an input;
providing a first test point and a second test point within the wireless transceiver that each are switchably connected to the input of the digital to analog converter by way of at least a first connection path and a second connection path between the first test point and the second test point, respectively, and the input of the digital to analog converter; and
providing control logic configured to activate the first connection path or the second connection path in response to a selection signal.

15. The method of claim 14 wherein providing a first test point and a second test point within the wireless transceiver comprises providing a plurality of multiplexers connected between the first test point, the second test point, and the digital to analog converter.

16. The method of claim 14 wherein providing control logic comprises providing a control register that is configured to select the first connection path or the second connection path, based on predetermined register values.

17. A method of testing a performance of an integrated circuit wireless transceiver comprising;
receiving a selection signal designating at least a first test point of at least a first test point and a second test point within a wireless transceiver;
activating a connection path between the first test point and a digital to analog converter, based on the selection signal;
providing an output of the digital to analog converter at a comparison circuit;
providing a test signal associated with the wireless transceiver to the comparison circuit; and
testing the test signal, based on an output of the comparison circuit.

18. The method of claim 17 wherein activating the connection path comprises activating at least one multiplexer connected between the first test point and the digital to analog converter, based on a register value within a control register that is set by the selection signal.

19. The method of claim 17 wherein providing a test signal comprises providing an input signal to an input stage of a receiver portion of the wireless transceiver, and wherein the first test point is associated with a digital output signal from the input stage of the receiver portion.

20. The method of claim 17 wherein the first test point is selected to be connected to an input to a digital signal processing stage of a receiver portion of the wireless transceiver, and/or wherein the second test point is selected to be connected to an output of the digital signal processing stage of the receiver portion.

21. A digital to analog converter comprising:
a plurality of current sources;
at least one bias generator configured to activate a subset of the plurality of current sources, based on a received digital signal;
an offset current source; and
an offset bias generator configured to activate the offset current source in response to an offset select signal indicating a presence of an offset within the received digital signal.

22. The digital to analog converter of claim 21 wherein the offset bias generator is configured to select a polarity of the offset current source, based on a polarity select signal.

23. The digital to analog converter of claim 21 wherein the bias generator is configured to activate the subset based on a coded representation of the received digital signal.

24. The digital to analog converter of claim 23 wherein the coded representation includes an un-equal number of positive and negative codes, the un-equal number resulting in the DC offset.

25. The digital to analog converter of claim 23 wherein the offset bias generator is configured to activate the offset current source, based on the coded representation.

26. The digital to analog converter of claim 23 comprising a binary-to-thermometer encoder configured to provide the coded representation.

27. The digital to analog converter of claim 21 wherein the digital to analog converter is implemented as a differential circuit.
